(19) United States
(12) Patent Application Publication
(10) Pub. No.: US 2017/0169443 A1
(43) Pub. Date: Jun. 15, 2017

(54) TAG LINK CREATION AND CAMPAIGN TRACKING

(71) Applicant: Taglynx, LLC, South Pasadena, CA (US)

(72) Inventor: Miguel Angel Martinez, JR., Los Angeles, CA (US)

(21) Appl. No.: 15/372,637

(22) Filed: Dec. 8, 2016

Related U.S. Application Data
(60) Provisional application No. 62/265,983, filed on Dec. 10, 2015.

(51) Int. Cl. G06Q 30/02; G06F 17/30; G06F 17/22; H04L 29/08

(52) U.S. Cl. CPC G06Q 30/0201; H04L 67/22; H04L 67/02; G06F 17/30312; G06F 17/30864; G06F 17/2235; G06F 3/0482

(57) ABSTRACT

The disclosure relates to tag linking systems and methods for tracking content distributed over networks, such as the Internet, and the creation of tag templates which may be loaded at a later time. Embodiments of tag linking systems and methods allow users to create and save naming conventions and easily switch between them. Embodiments of tag linking systems and methods automatically validate links supplied by the user.

### CROSS-REFERENCE TO RELATED APPLICATIONS

This application claims the benefit of U.S. Provisional Patent Application No. 62/265,983, filed on Dec. 10, 20115.

### FIELD OF INVENTION

The invention(s) disclosed herein relate to technologies for improving the ability to track user behavior on computer networks and the Internet, and to systems and methods for creating and managing link-tagging campaigns on computer networks and the Internet.

### BACKGROUND

Businesses increasingly spend significant amounts of money marketing to customers over the Internet, including through social media websites, advertising networks, search engines, and other platforms E-mall is also an important marketing tool for reaching potential customers and directing them to a destination on the Internet.

A problem with Internet marketing is that there are many available options for reaching potential customers, and it can be difficult to determine which platforms are the most effective. For example, is it better to spend advertising dollars to promote a business on Facebook™ or on Google™? if a business can determine which platforms attract the most customers for the least amount of money (e.g., least dollars per customer or per sale), then the business can be more efficient with its marketing budget.

A related problem is that, even within a particular platform, there are often many different audiences and many ways to target a particular audience. For example, marketers on Facebook™ can target their campaigns to specific audiences based on gender, age, location, and/or interests. If a business can determine which audience is most interested in its products and services and what message is most effective at attracting that audience, then the business can be more successful.

Various services have arisen to help businesses gauge the effectiveness of their Internet marketing campaigns. Some services allow businesses to identify the source of traffic to their websites by tracking the links that visitors click to arrive at a website owned by the business. If a business can determine the source of traffic to its website (e.g., Facebook™ versus Goole™), it can use this information to help determine which platforms are most effective at reaching potential customers. Google Analytics™ is a popular service for link tracking. By embedding code on their website, businesses can use Google Analytics™ to determine what links users clicked to reach their website. Another popular link tracking service is Adobe Analytics™.

The links used to reach a webpage may be different, even though they direct a user to the same webpage, because some characters in a link may be ignored for Internet routing purposes. For example, a question mark (“?”) and subsequent characters are typically ignored for purposes of routing to a target website, however, these ignored characters may be tracked by a link-tracking or analytics service. Thus, a marketer may use these ignored characters to create campaign identifiers (or “tags”) to identify and track the performance of a particular campaign.

A marketer may use tags within links placed on different websites (e.g., Facebook™, Google™, YouTube™, Pinterest™, etc.) to determine the source of traffic to the business's website. For example, the following two URLs might be used to track the source of the traffic to the website www.example.com:

http://www.example.com?source=facebook

http://www.example.com?source=youtube

In this example, the links would direct the customer to the same destination page owned by the business—www.example.com—but the source of the traffic—Facebook™ or You Tube™—could be tracked separately by analytics software, assuming that the appropriate link was placed on each platform. Notably, the choice of “source=” and then writing the name—e.g., “facebook”—is a choice made by the business and not a required format. A business could choose to use a different format for tags that identify the source of the traffic, for example, by abbreviating the terms, such as “src=fbk” to identify Facebook™ as the source. These tag formats may also he referred to as “naming conventions.”

Businesses also may use different links on the same marketing website or platform to determine which particular message is most effective. For example, a business could have two different advertising campaigns on Facebook™ targeting different types of customers (e.g., men vs. women; older vs younger; etc.) using different images and copy. By using different tags within the links to identify each campaign, the business may determine which campaign is more successful at attracting customers. And, of course, many different campaigns and tags may be used, not just two.

Several services exist for helping businesses to manage the process of creating links for their campaigns. For example, Google™ and Facebook™ both provide such a service, and lesser known companies also provide this service. However, existing services suffer from several deficiencies. A problem for marketers is that they frequently have to create many campaigns for multiple businesses or product lines, which can be very repetitive and time consuming. Businesses typically have rules that they follow for tagging campaigns. Each time a new campaign is created, the marketer must create all the tags and ensure that they comply with the rules set by the business, even though man of the tags may be the same. Using existing services, this process requires a lot of time-consuming repetition. Existing services do not allow marketers to create and save templates for their tags, which can be loaded and used again at a later time.

Another problem is that marketers serving multiple clients often need to create different naming conventions for each client. Switching frequently between naming conventions can cause error and is also quite time-intensive and repetitive. Existing services do not provide marketers with a tool to easily switch between naming conventions for each client. A related problem is that existing services do not provide a wizard or similar interface for easily creating naming conventions. Thus, creating a new naming convention (or switching between them) requires a lot of work by the marketer and is prone to errors.

Yet another problem is that marketers sometimes enter the links incorrectly, for example, because of typing mistakes. This a serious problem because incorrect links may direct potential customers to an inactive webpage, which can cause lost sales and hurt the business's reputation. This problem is particularly great when marketers are linking to many different webpages or websites across campaigns. Existing services do not provide a tool for automatically validating the link supplied by the marketer.

Thus, there is a need in the art for a tag linking technology that allows users to create and save tag templates that can he loaded at a later time. There is also a need in the art for a tag linking technology that allows users to easily create new naming conventions and switch between them. There is also a need in the art for a tag linking technology that automatically validates links supplied by the marketer.

### SUMMARY OF THE DISCLOSURE

The present disclosure includes embodiments of tag linking systems and methods that allow users to create and save tag templates that can be loaded at a later time. The present disclosure includes embodiments of tag linking systems and methods that allow users to create and save naming conventions and easily switch between them. The present disclosure includes embodiments of tag linking systems and methods that automatically validate links supplied by the user.

Embodiments include a non-transitory computer readable medium storing instructions that cause a computer to execute a process for generating tag links. The process may include sending content over a computer network, and the content may include information for displaying a graphical user interface with variables to include in a tag link. Values corresponding to the variables may be received over the computer network, a request may be received over the computer network to save the values, and the values may be saved in response to the request.

Embodiments include a non-transitory computer readable medium storing instructions that cause a computer to execute a process for creating a naming convention. The process may include displaying a first prompt for selecting an analytics platform, receiving a first selection of the analytics platform, displaying a second prompt for selecting one or more media types, receiving a second selection of the one or more media types, displaying a third prompt for entering at least one source and at least one corresponding source acronym, and receiving an entry of the at least one source and the at least one corresponding source acronym. The naming convention may be generated based at least in part on the first selection, the second selection, and the entry. The naming convention may be stored in memory.

Embodiments include a server having a processor, a memory, and a web portal capable of sending and receiving information over the Internet. The web portal may receive values over the Internet and store the values in memory, and the web portal may use the values to generate tag links and send the tag links over the Internet.

The foregoing discussion in the Summary of the Disclosure is for example only and is not intended to limit the scope of the claimed invention(s) or the embodiments described below.

### BRIEF DESCRIPTION OF THE DRAWINGS

FIG. 1 shows an embodiment of a tag link system and a tag link server.

FIG. 2 shows an embodiment of a page for creating tags and naming conventions that may be displayed via a web browser.

FIGS. 3A-4 show an example of a sequence of screenshots that may be used in embodiments of a naming convention wizard.

FIG. 4 shows an example of a flow chart for steps that may be performed by embodiments of a tag link server during the creation of a tag template.

### DETAILED DESCRIPTION

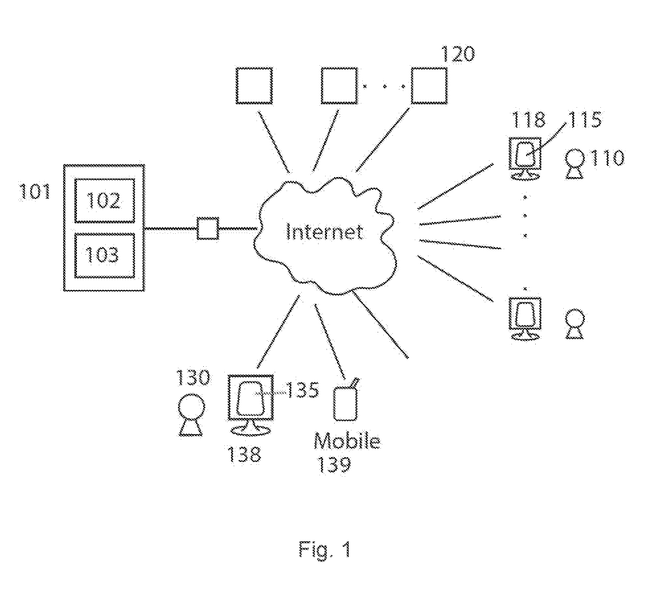

As shown in FIG. 1, in embodiments of a tag link system, tag link server 101 may be connected to the Internet. Marketers 110 may obtain access to web portal 102 running on tag link server 101 via the Internet using browser 115 running on client computer 118. Browser 115 may be any web browser capable of accessing and displaying content from the Internet, such as Microsoft Explorer™, Google Chrome™ or Safari™. Web portal 102 may include application software running on tag link server 101. Browser 115 may display a graphical user interface in response to information, received over the Internet from web portal 102. Web portal 102 may be capable of serving one or more web pages with HTML and CSS content over the Internet, including dynamic content generated using one or more of PHP, javaScript, Java, Python, Ruby, and/or other suitable computer languages, as would be understood by a person of skill in the art in view of the present disclosure. In embodiments of a tag link system, computer instructions for web portal 102 may execute on one or both of tag link server 101 and client computer 118.

Tag link server 101 may include database 103, which may be provided using Microsoft SQL server, Microsoft Access, Oracle, My SQL, SQLite, or other suitable database software, as would be understood by a person of skill in the art in view of the present disclosure. Database 103 may store information regarding accounts created through web portal 102 and/or other information used to deliver services through web portal 102. Tag link server 101 may be a single physical machine, a virtual machine, or distributed across multiple physical machines.

As one of skill in the art would understand in view of the present disclosure, the various servers and computers shown in FIG. 1 may connect to the Internet via routers, firewalls, and/or other network components not explicitly illustrated. For example, client computers 118 used by marketers 110 may sit within a company intranet that connects to the Internet via a firewall and a router. Alternatively, client computers 118 may connect to the Internet directly. As another example, Tag link server 101 may connect to the Internet via a router and/or firewall.

Marketer 110 may create an account for a business through web portal 102. After creating an account, marketer 110 may login to the account via web portal 102 by entering a username and password, for example. Marketer 110 may then use web portal 102 to create one or more links with campaign tags. The campaign links may be placed on various online platforms 120 (e.g., Facebook™, YouTube™, Pinterest™, Instagram™, etc.) together with other marketing information, such as images and text, in order to attract customers 130. Campaign links may also be distributed through other means, such as embedded within an e-mail distributed to a list or presented to customers through advertising networks, such as Google AdSense™.

A customer 130 visiting online platforms 120 (e.g., Facebook™) using browser 135 on computer 138 (or mobile device 139) may be presented with an advertisement that includes a link generated by tag link server 101. Upon clicking the link, customer 130 may be directed to a destination website based on the link. For example, when creating the link, marketer 110 may enter a URL for a destination website owned by the marketer's business or by the marketer's client; when customer 130 clicks on the link, then browser 135 may be directed to that destination website. If the link includes campaign tags, then analytics software may be used to track the success of the associated marketing campaign—for example, how many visitors to the destination website clicked on the link—and other metrics.

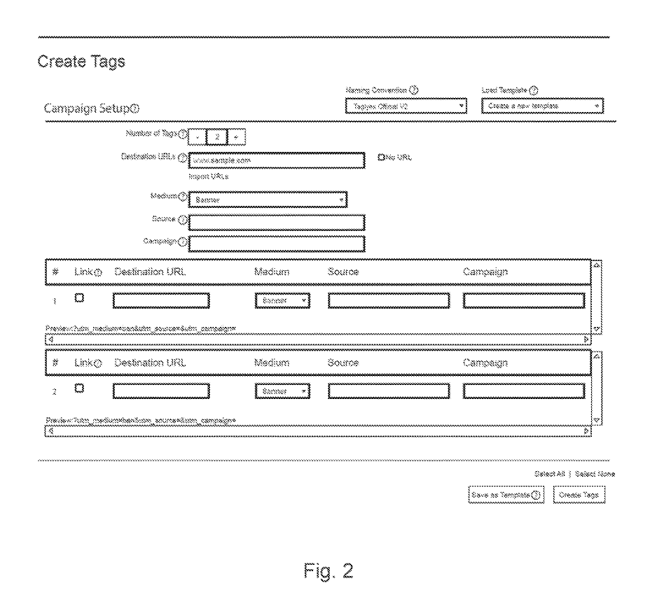

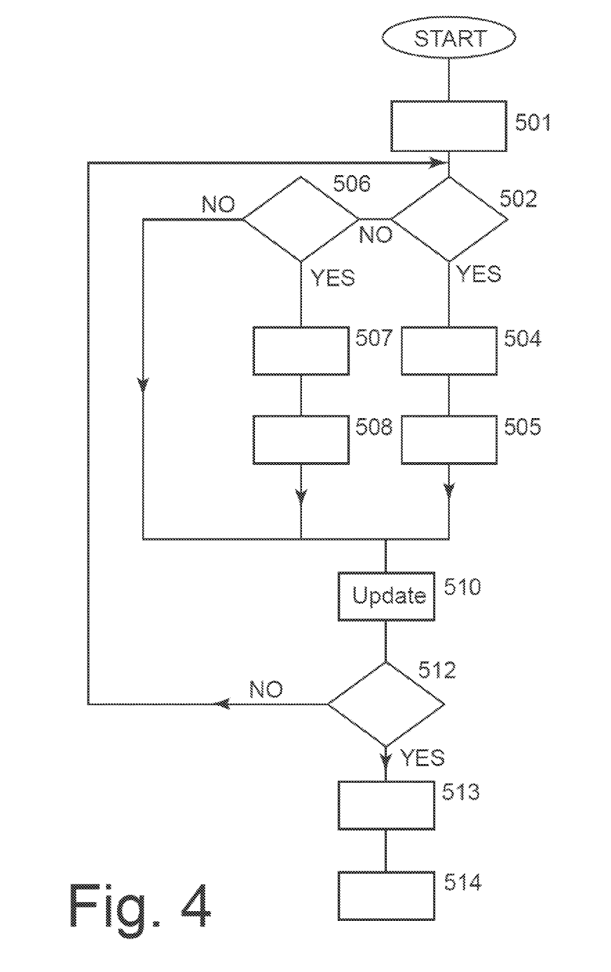

In embodiments of a tag link system, marketers 110 may create and save templates for their tags, and the templates may be loaded and used again at a later time, thereby avoiding unnecessary repetition and minimizing errors. Web portal 102 may include one or more web pages for creating tags. FIG. 2 shows an example of a tag creation page that may be provided to marketer 110 on browser 115 via web portal 102. As shown in FIG-, 2, marketer 110 may select a naming convention for the campaign, such as Google Analytics™, Adobe Analytics™, or a custom naming convention previously created and saved for the account, as described below with reference to FIGS. 4A-D. Marketer 110 may specify first level variables, such as a number of tags to create and one or more destination websites. The destination website typically would be the website to which marketer 110 wants to direct customers. For example, the destination website may be the URL of the marketer's business or client. In FIG. 2, the destination URL is shown as “www.example.com”

Marketer 110 also may specify one or more second level variables, such as a channel for delivery (e.g., email, social media, display advertising, search engine marketing, etc.), gender of the target audience, frequency of recurrence (e.g., weekly, bi-weekly, monthly), target device type (e.g., mobile phone, tablet, desktop), date sent, and/or campaign name. These variables are optional depending on the needs of marketer 110 and the business. Certain variables may be provided by default; however, different variables may be specified when creating or editing a naming convention. In embodiments of web portal 102, variables may be created, edited, grouped, and/or deleted directly through the tag creation page. The variable “levels” shown in the example of FIG. 2 are provided for the convenience of marketer 110. However, it is not necessary to split the variables into levels or groups; in embodiments of web portal 102, the variables may be grouped differently or included in a single grouping.

As shown at the bottom of FIG. 2, the tag creation page may include a section for customizing tags to use with a campaign. The values previously entered for the variables (e.g., as first and second level variables) may be used to automatically pre-populate the custom tags section. However, a Marketer 110 may change the pre-populated values, for example, by selecting a different value from a dropdown menu or by entering a new value. Marketer 110 may also specify custom destination URLs, such as a specific page within the destination website. The tag creation page may include a button (or other selectable interface) for saving the entered values as a tag template; in the example of FIG. 2 the button is labeled “Save as Template.” When the “Save as Template” button is clicked or otherwise selected, web portal 102 may prompt marketer 110 to enter a name for the template, and the name may be saved as an identifier for the template to be displayed later. In some embodiments, a default name for the tag template may automatically be generated by web portal 102. The template name and tag values may be saved in database 103 for future access by web portal 102.

Once a tag template is saved, the name associated with the tag template may become available in a “Select Template” area on the tag creation page and/or elsewhere within web portal 102. Marketer 110 may select a tag template by its name—for example, using a dropdown menu—in order to load the previously saved values associated with the template and stored in database 103. Marketer 110 may then change the loaded tag values and/or enter additional values as needed. In some embodiments, web portal 102 may dynamically generate a live preview of the tag links that will be generated, which advantageously may make it easier for marketer 110 to ensure the information is correct. When marketer 110 is ready to generate tag links for the campaign, marketer 110 may select the “Create Tags” button. When the “Create Tags” button is selected, tag link server 101 may generate the tag links and display them through web portal 102. Marketer 110 may then use the generated tag links in its marketing campaigns, for example, by placing them on online platforms 120 or distributing them via e-mail.

The saved tag template may include all or some of the tag values that were displayed on the tag creation page when marketer 110 selected “Save as Template.” In some embodiments, it may be advantageous to save fewer than all of the tag values, for example, because some tag values may change frequently and may need to be updated when new links are generated. If some tag values are not loaded with the saved template, then marketer 110 may be required to enter those values before generating tag links from the template. For example, dates or campaign identifiers may not be saved in some embodiments, and marketer 110 may be required to enter those values before the system will generate tag links.

In embodiments of a tag link system, tag link server 101 may automatically validate the generated tag links and display a notification through web portal 102 if there are errors. For example, tag link server 101 may check the link validity by attempting to access the generated tag link(s) and detecting the returned HTTP status code. If the HTTP status code indicates an error—such as a 404 (page not found) error—web portal 102 may display an error notification on browser 115. Other HTTP status codes also may indicate an error, such as 301 (moved permanently), 401 (unauthorized), 403 (forbidden), 410 (gone), 501 (not implemented), 503 (service unavailable), and 550 (permission denied), among others. A notification may also be provided on a graphical user interface in browser 115 that the generated tag link(s) are valid. Advantageously, this process of automatically checking the validity of the tag links saves time for marketer 110 and reduces the chance of errors.

In addition to checking validity of the link in embodiments of a tag link system, tag link server 101 may check for one or more of the following: all required tag fields are filled; tag fields only contain valid URL characters; the full URL is less than 2083 characters (or some other limit) due to browser limitations; correct URL syntax relating to the Query String is employed, such as use of one question mark (“?”) and trailing ampersand (“&”), for example, as specified in the naming convention. A notification may be provided through web portal 102 and displayed through a graphical user interface in browser 115 if any errors are detected.

A naming convention is a set of rules for how the tag is structured. For example, a naming convention template may specify which variables to require, how to represent the variables, the available options for the variables, the order of the variables, and how to separate (or delimit) the variables. Referring to the example shown in FIG. 2, a naming convention template may first require selection of the channel type (e.g., social), then require selection of the specific channel (e.g., Facebook™ or “fb”), then selection of the date posted, and finally entry of the campaign name. In embodiments of a tag link system, default naming convention templates may be provided for use by marketers 110. The default naming convention templates may be designed for use with popular link tracking services, such as Google Analytics™ or Adobe Analytics™ Notably, Google Analytics™ requires certain variables to appear in a specific format—for example, Google requires “utm_medium”, “utm_source”, and “utm_campaign” query parameters, which may be built into a default template for use with Googie Analytics™' Providing default naming convention templates makes it easier for marketers 110 to quickly begin creating tag links for their campaigns. Starting from a naming convention template (whether default or selected), marketer 110 may specify values for the required variables and save them as a tag template, as previously described with respect to FIG. 2.

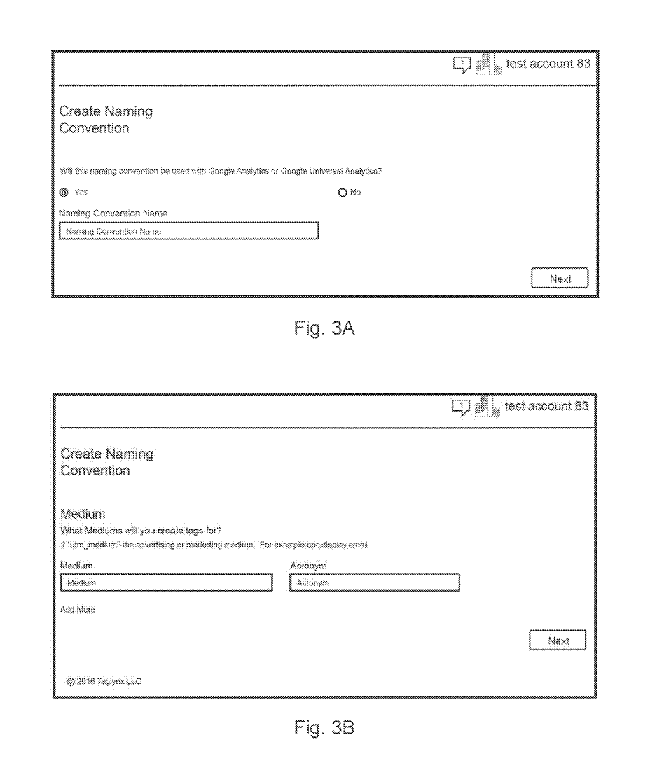

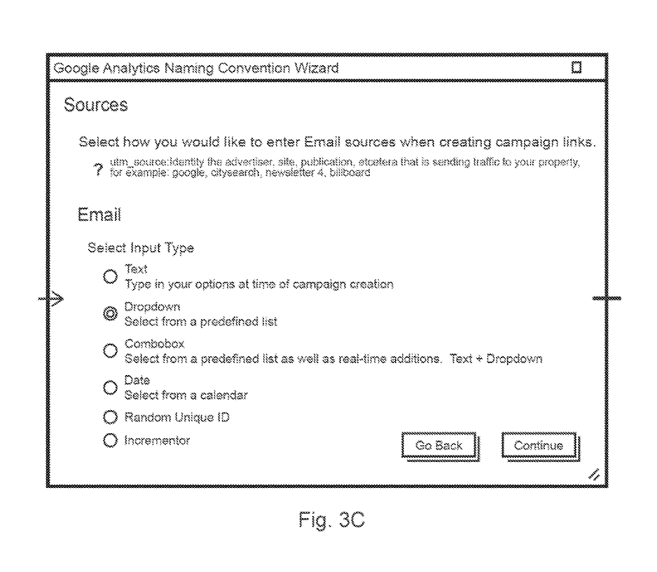

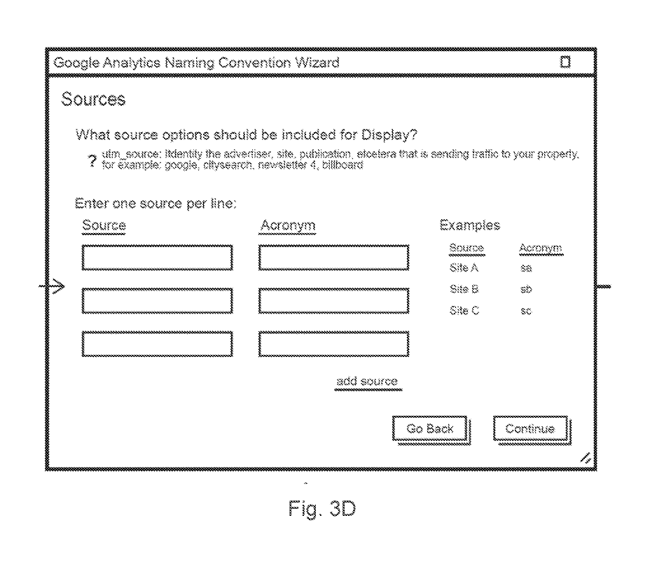

In embodiments of a tag link system, a wizard or other graphical user interface (“GUI”) may be provided through web portal 102 for easily creating a new naming convention by loading a naming convention template, which may be pre-defined and stored in memory on tag link server 101 FIGS. 3A-D show an example of a sequence of screenshots that may be used in embodiments of a naming convention wizard. In FIG. 3A, the wizard may prompt marketer 110 to select whether the naming convention is for Google Analytics™ or Google Universal Analytics™; if yes, then the wizard may automatically include certain required variables in the naming convention. As shown in FIG. 3B, the wizard may next prompt marketer 110 to select what media the tags are being created for, such as CPC, email, or display. As shown in FIG. 3C, the wizard may then prompt marketer 110 to specify how to display the options for each selected media type, for example, as text, constant, dropdown, combobox, date, random unique ID, or incrementor. As shown in FIG, 3D, the wizard may next prompt marketer 110 to specify which source options should be included for each selected media type. For example, for “display” media, the source options may include a list of abbreviations for various online platforms, such as Facebook™. YouTube™, and Pinterest™, When the naming convention is loaded and displayed, the list of sources may be displayed according to the previous selection in FIG. 3C, e.g., as a dropdown menu. In this way, the wizard may continue to prompt the user for the variables to include in the naming convention, how to display them, and what options to provide. The wizard may prompt marketer 110 to select how to display other variables, such as campaign name, date, keyword and/or gender. The wizard may also allow marketer 110 to specify custom variables relevant to a campaign. As one of skill in the art would understand in view of the present disclosure, the wizard (or GUI) may prompt the user to enter the variables and make selections in different orders and prompts may be grouped together rather than displayed on multiple screens.

After completing the wizard, the information provided by marketer 110 may be used to generate and save a naming convention in database 103, which may be identified using a name provided by marketer 110 (e.g., “My Company Naming Convention”).

The wizard also may allow marketer 110 to specify custom query delimiters. Query delimiters may be used to separate the variables and values included in the tag link for parsing by analytics or other tracking software.

FIG. 4 shows an example of a flow chart for steps that may be performed by web portal 102—which may run on tag link server 101—during the creation of a tag template. In step 501, web portal 102 may send content for a “Create Tag” page to browser 115 running on client computer 118. For example, the “Create Tag” content may be sent in response to a request from browser 115 to access the corresponding page. Upon receipt of the content, browser 115 may display a “Create Tag” page to marketer 110 using a default template or customized naming convention. In step 502, web portal 102 may determine if a request received from browser 115 is to load a saved tag template. For example, a request to load a saved tag template may be initiated by user input from marketer 110. If yes, then the flow may proceed to step 504, where web portal 102 may retrieve information stored in database 103 for the saved tag template. The saved tag template may be specified by an identifier—such as the name (e.g.,“My First Template”)—included in the request. The information retrieved from database 103 for the saved tag template may include variables and values to be displayed on browser 115. In step 505, at least some of the retrieved information for the saved tag template may be sent to browser 115, where the information may be used to refresh the content displayed on the “Create Tag” page. The information may be sent by web portal 102 together with other content. The flow may then proceed to step 510.

In step 503, if the request is not to load a saved template, then the flow may proceed to step 506, where web portal 102 may determine if a request received from browser 115 is to select a naming convention. If yes, then the flow may proceed to step 507 and information for a saved naming convention specified in the request (e.g., by name) may be retrieved from database 103. The information retrieved for the saved naming convention may include the variables associated with the naming convention to be displayed on browser 115. In step 508, at least some of the retrieved information for the saved naming convention may be sent to browser 115, where the information may be used to refresh the variables displayed on the “Create Tag” page. The information may be sent by web portal 102 together with other content. The flow may then proceed to step 510. In step 506, if the request is not to select a naming convention, then the flow also may proceed to step 510.

In step 510, the variables and/or values displayed on the “Create Tag” page on browser 115 may be updated in response to user input provided by marketer 110 through client computer 118. In some embodiments, web portal 102 may dynamically update the displayed content in response to user input (e.g., using AJAX) and store the updates on tag link server 101. In other embodiments, the updates made by marketer 110 may be stored locally on client computer 118 and/or browser 115 until marketer 110 initiates a request to save the information (e.g., using an HTTP GET or POST request). In step 510, marketer 110 may enter any required information that was not loaded with the saved tag template or saved naming convention.

In step 512, web portal 102 may check for a request to save information on the “Create Tag” page as a tag template, for example, in response to marketer 110 selecting a “Save as Template” button. If a request to save a tag template is received, then in step 513, browser 115 may prompt marketer 110 to enter a name for the tag template to be saved. Once a name is entered, in step 514, web portal 102 may save information on “the Create Tag” page variables and their associated values) and the name (or other identifier) as a tag template in database 103 for future retrieval. In step 512, if the request is not to save a tag template, then the flow may return to step 502 to determine if another request has been received.

In view of the present disclosure, one of skill in the art would understand that the steps of FIG. 4 need not occur precisely in the order shown. For example, web portal 102 may be configured to identify and respond to any type of request—e.g., load a template, load a naming convention, save a template—asynchronously whenever the request is received.

Embodiments of tag link server 101 described herein improve the performance of computer systems and the Internet by making it easier to link relevant content, create consistent campaign identifiers, and track campaigns. Embodiments of tag link server 101 described herein improve server performance by saving information which may be loaded at a later time.

It should be understood that, while various embodiments have been described herein, the claimed invention(s) should not be limited by those embodiments. To the contrary, the foregoing summary, detailed description, figures, and abstract have been presented for illustrative purposes, and are not meant to limit the claims. Indeed, as a person of skill in the art in view of the present disclosure would recognize, various changes can be made to the embodiments described herein without departing from the scope and spirit of the present invention(s).

1. A non-transitory computer readable medium storing instructions that cause a computer to execute a process for generating tag links, the process comprising:
sending content over a computer network, wherein the content comprises information for displaying a graphical user interface with variables to include in a tag link;
receiving values over the computer network, wherein the values correspond to the variables;
receiving a request over the computer network to save the values;
saving the values in response to the request, thereby improving the efficiency of the computer.

2. The non-transitory computer readable medium of claim 1, wherein the values are saved by storing the values in a database as a template.

3. The non-transitory computer readable medium of claim 2 wherein the process further comprises:
retrieving the saved template from the database and sending the values over the computer network for display in the graphical user interface.

4. The non-transitory computer readable medium of claim 1, wherein the process further comprises:
generating the tag link using the values and sending the tag link over the computer network for display in the graphical user interface.

5. The non-transitory computer readable medium of claim 4, wherein the process further comprises:
automatically validating the tag link, and
sending an error notification over the computer network for display in the graphical user interface if there is an error with the tag link.

6. The non-transitory computer readable medium of claim 5, wherein automatically validating the tag link comprises attempting to access the URL specified by the tag link and checking an HTTP status code.

7. The non-transitory computer readable medium of claim 5, wherein automatically validating the tag link comprises at least one of:
checking that all required values for the tag link are filled;
checking that all of the values only contain valid URL characters; and
checking the syntax of the tag link to ensure that it complies with a naming convention.

8. The non-transitory computer readable medium of claim 1, wherein the graphical user interface comprises an expandable dropdown element for specifying at least one of the values.

9. The non-transitory computer readable medium of claim 1, wherein the graphical user interface comprises a constant for specifying at least one of the values.

10. The non-transitory computer readable medium of claim 1, wherein the computer network comprises the Internet.

11. A non-transitory computer readable medium storing instructions that cause a computer to execute a process for creating a naming convention, the process comprising:
displaying a first prompt for selecting an analytics platform;
receiving a first selection of the analytics platform;
displaying a second prompt for selecting one or more media types;
receiving a second selection of the one or more media types;
displaying a third prompt for entering at least one source and at least one corresponding source acronym;
receiving an entry of the at least one source and the at least one corresponding source acronym;
generating the naming convention based at least in part on the first selection, the second selection, and the entry; and
storing the naming convention in a memory, thereby improving the efficiency of the computer.

12. The non-transitory computer readable medium of claim 11, wherein the process further comprises:
generating a fourth prompt for selecting how the at least one source should be displayed on a graphical user interface.

13. The non-transitory computer readable medium of claim 11, wherein the process further comprises:
generating a fourth prompt for selecting a custom query delimiter, wherein the custom query delimiter separates values in a tag link.

14. The non-transitory computer readable medium of claim 11, wherein the process further comprises:
generating a fourth prompt for specifying an input type, wherein the input type is one of a text field, a constant, a dropdown, a combobox, a date, a random unique ID, or an incrementor.

15. The non-transitory computer readable medium of claim 11, wherein the process further comprises:
retrieving the naming convention from the memory; and
displaying the naming convention on a graphical user interface.

16. The non-transitory computer readable medium of claim 11, wherein the process improves the efficiency of a computer network by linking relevant content and tracking campaigns.

17. A server comprising:
a processor;
a memory; and
a web portal capable of sending and receiving information over the Internet.
wherein the web portal receives values over the Internet and stores the values in memory, and
wherein the web portal uses the values to generate tag links and sends the tag links over the Internet.

18. The server of claim 17, wherein the server improves the efficiency of a computer network by linking relevant content and tracking campaigns.
